(19) United States
(12) Patent Application Publication
(10) Pub. No.: US 2023/0290280 A1
(43) Pub. Date: Sep. 14, 2023

(54) SURGICAL TRAINING MODEL INCLUDING A SIMULATED HUMAN UTERUS AND ASSOCIATED METHODS

(71) Applicant: INTUITIVE SURGICAL OPERATIONS, INC., Sunnyvale, CA (US)

(72) Inventors: Richard H. FEINS, Chapel Hill, NC (US); John C. ALEXANDER, JR., Pinehurst, NC (US); Jay ROHDE, Chapel Hill, NC (US); Margaret MONACO, Cary, NC (US); Joanna CAO, Durham, NC (US)

(73) Assignee: INTUITIVE SURGICAL OPERATIONS, INC., Sunnyvale, CA (US)

(21) Appl. No.: 18/177,161

(22) Filed: Mar. 2, 2023

Related U.S. Application Data
(60) Provisional application No. 63/269,043, filed on Mar. 9, 2022.

(51) Int. Cl. G09B 23/30; G09B 23/34

(52) U.S. Cl. CPC G09B 23/306; G09B 23/34

(57) ABSTRACT

A surgical training model for simulating gynecological surgery may include a simulated human uterus. A first inner portion may include harvested porcine uterus and a second outer portion may include harvested porcine tissue that surrounds the first inner portion. The simulated human uterus may be sized and shaped to replicate a human uterus. A simulated human broad ligament may include porcine tissue.

### PRIORITY APPLICATION(S)

This application is based upon U.S. provisional patent application Ser. No. 63/269,043 filed Mar. 9, 2022, the disclosure which is hereby incorporated by reference in its entirety.

### FIELD OF THE INVENTION

The present invention is directed to surgical training, and more particularly, to a surgical training model and related methods.

### BACKGROUND OF THE INVENTION

Surgical procedures may be performed using open or general surgery, laparoscopic surgery, and/or robotically assisted surgery. To become qualified to perform surgical procedures, surgeons participate in comprehensive training to become proficient in the variety of tasks required to perform the procedures. Such tasks include inserting and directing surgical tools to anatomical features of interest such as tissue or organs, manipulating tissue, grasping, clamping, cutting, sealing, suturing, and stapling tissue, as well as other tasks. To gain proficiency, it is beneficial to allow surgeons to repeatedly practice these tasks for multiple different procedures. In addition, it can be beneficial to quantify training and performance of such tasks by surgeons, thereby enabling them to track progress and improve performance.

Various surgical training systems have been developed to provide surgical training. For example, training may be conducted on human cadavers. However, cadavers may be expensive and provide limited opportunities to train. In addition, a single cadaver may not allow the surgeon to repeatedly practice the same procedure. Surgical tissue models have also been utilized for surgical training. However, these tissue models may not be suitable for training minimally invasive procedures using laparoscopic or robotically assisted tools. In minimally invasive procedures, the surgical tools must be inserted into the body via natural orifices or small surgical incisions and then positioned near the anatomical features of interest.

Harvested porcine tissue has been used to develop surgical training models for use in thoracic and cardiac surgery because the anatomy of the porcine organs, such as the heart and lungs, are similar in anatomy to human organs. However, harvested porcine tissue to simulate the female pelvic organs in a human has not been found acceptable because the uterus in many animals and especially the pig is bifid, having a deep cleft or notch in the uterus, making its use unacceptable to simulate the human uterus.

Additionally, in the pelvic area of a human female, the female genital organs are suspended by various structures and ligaments, such as the broad ligaments, which in a pig are too thin to be used to simulate the female pelvic area and its ligaments. For that reason, harvested porcine tissue and other harvested animal tissue has not been acceptable for use in simulating a female human pelvis with its associated female organs for use in surgical training, such as benign and malignant gynecological (GYN) surgery and other related surgeries.

### SUMMARY OF THE INVENTION

This summary is provided to introduce a selection of concepts that are further described below in the Detailed Description. This summary is not intended to identify key or essential features of the claimed subject matter, nor is it intended to be used as an aid in limiting the scope of the claimed subject matter.

A surgical training model for simulating gynecological surgery may include a simulated human uterus that may comprise a first inner portion comprising a harvested porcine uterus, and a second outer portion comprising harvested porcine tissue. The second outer portion may surround the first inner portion. The simulated human uterus may be sized and shaped to replicate a human uterus. A simulated human broad ligament may comprise porcine tissue.

The second outer portion of the simulated human uterus may comprise harvested porcine tissue other than a porcine uterus. The second outer portion may comprise harvested porcine stomach. The simulated human uterus may comprise a third intermediate portion comprising a spacer that may comprise synthetic material. The spacer may be positioned between the first inner portion and the second outer portion. A harvested porcine vagina may be coupled to the harvested porcine uterus to define a simulated human vagina. The simulated human broad ligament may comprise harvested porcine leaf fat membrane.

A harvested porcine ureter may be coupled to the second outer portion to define a simulated round ligament. A harvested porcine ureter may be coupled to the second outer portion to define a simulated human ovarian ligament. A harvested porcine ureter may be coupled to the second outer portion to define a simulated human uterine artery. A pump may be coupled to the harvested porcine ureter to simulate human blood flow through the simulated human uterine artery.

A harvested porcine bladder and associated urethra may be adjacent the second outer portion to define a simulated human bladder and associated urethra. A harvested porcine colon may be adjacent the second outer portion to define a simulated human colon. A tissue cassette may receive the simulated human uterus and human broad ligament. The tissue cassette may be configured to be removably coupled to a mannequin. The simulated human uterus and broad ligament may include at least one colored dye to impart a dyed color to the simulated human uterus and broad ligament. The simulated human uterus and broad ligament may maintain their dyed color after freezing and thawing.

A surgical training model in another example may comprise a compressible spacer having a recess therein and a harvested porcine stomach around the spacer. A harvested porcine uterus portion within the recess may define a simulated human uterus. Harvested porcine ligament-simulating tissue may be coupled to the harvested porcine stomach to define a simulated at least one human ligament.

A harvested porcine vagina may be coupled to the harvested porcine uterus portion to define a simulated human cervix and vagina. The compressible spacer may comprise a compressible tubular body. The harvested porcine ligament-simulating tissue may comprise harvested porcine leaf fat membrane to define a simulated at least one human broad ligament. The harvested porcine ligament-simulating tissue may comprise a harvested porcine ureter to define a simulated at least one round ligament. The harvested porcine ligament-simulating tissue may comprise a harvested porcine ureter to define a simulated at least one human ovarian ligament.

A method for making a surgical training model may comprise positioning a harvested porcine stomach around a spacer having a recess therein, and positioning a harvested porcine uterus portion within the recess to define a simulated human uterus.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is a schematic diagram of the surgical training model showing the simulated human uterus and supporting broad ligaments using harvested porcine tissue according to an example embodiment of the disclosure.

FIG. 2 is another schematic diagram of the simulated human uterus and supporting ligaments.

FIG. 3 is an image of a portion of the surgical training model showing the simulated human uterus and the broad and other ligaments from harvested porcine tissue.

FIG. 4 is another image of a portion of the surgical training model showing the simulated human uterus that is sandwiched between the simulated broad ligaments from harvested porcine tissue.

FIG. 5 is an end view of the tissue cassette platform showing the surgical training model retained thereon.

FIG. 6 is a plan view of the tissue cassette platform shown in FIG. 5.

FIG. 7 is a top view image of the surgical training model showing the simulated human uterus, simulated ligaments and other organs derived from the harvested porcine tissue.

FIG. 8 is another top view image of the surgical training model similar to that of FIG. 7, but showing the exposed simulated human uterus, simulated ligaments, and other organs.

FIG. 9 is a flowchart showing a method for making the surgical training model.

FIG. 10 is a perspective view of a manipulator system according to an example embodiment of the disclosure.

FIG. 11 is a partial schematic view of an embodiment of a manipulator system having a manipulator arm with two instruments in an installed position according to the present disclosure.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

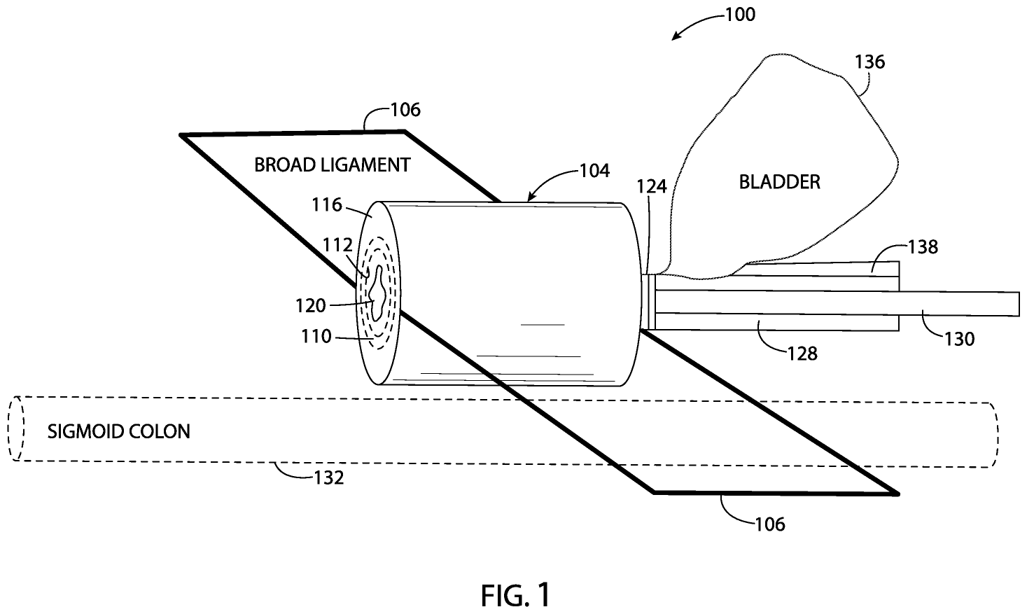

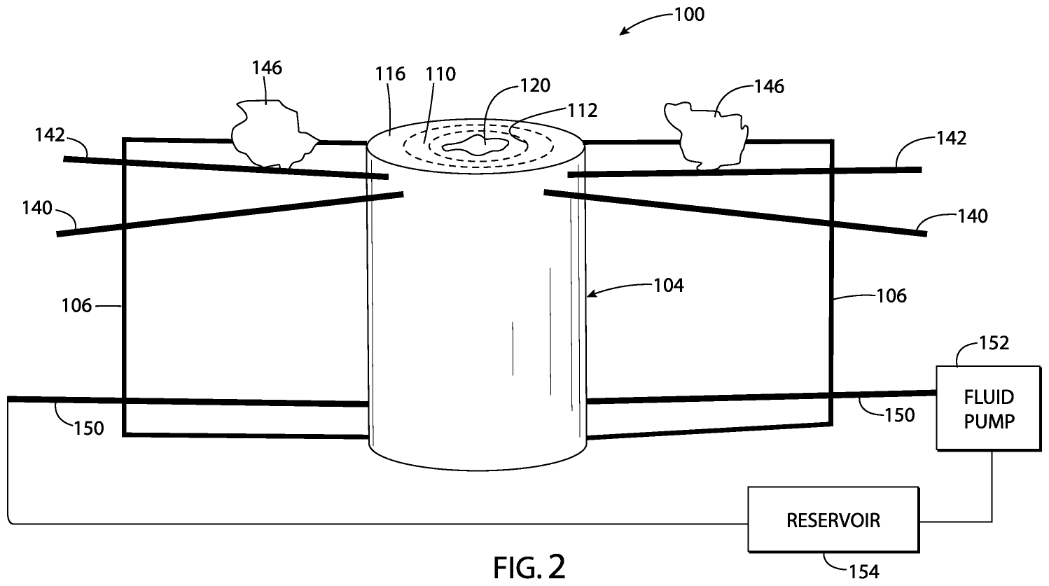

Referring now to FIGS. 1 and 2, there are illustrated schematic diagrams of a surgical training model 100 that includes a simulated human uterus 104 and at least one supporting human simulated broad ligament 106, shown as left and right broad ligaments, and associated organs that simulate the human female pelvic area for surgical training. The surgical training model 100 may optionally include a spacer shown by the area between the dashed lines 110 to increase a diameter of the simulated human uterus 104. The optional spacer may have a recess 112 therein. The optional spacer 110 may be formed from a compressible tubular body, such as a foam material. In an example, the optional spacer 110 may be formed from 1.5 inch to 2.0 inch diameter foam pipe insulation that is about 3.0 inches long. Other materials may be used to construct a preformed core, including any material that can be molded or formed to look like the shape of a uterus. A harvested porcine stomach 116 is wrapped around the optional spacer 110 to form the outer section of the simulated human uterus 104. A harvested porcine uterus portion shown schematically at 120 is within the recess 112 of this optional spacer 110 to define the simulated human uterus 104 and may be formed from a trimmed natural porcine uterus that is pulled through the recess 112. The trimmed natural porcine uterus includes the harvested porcine vagina that is coupled to the harvested porcine uterus portion 120 to define a simulated human cervix shown by the smaller width section at 124 and the vagina shown by the longer section at 128. A synthetic vaginal manipulator 130 is shown inserted within the vagina 128.

Because the porcine ligaments that support the pelvic area in a pig are thin, harvested porcine leaf fat membrane forms the simulated human broad ligaments 106 and is coupled to the harvested porcine stomach 116 as shown by the solid rectangular outline in the schematic diagrams of FIGS. 1 and 2 to simulate the human broad ligaments. As further shown in FIG. 1, a harvested porcine colon 132 may be adjacent the harvested porcine stomach 116 to simulate a human sigmoid colon. A harvested porcine bladder 136 and associated urethra 138 may be adjacent to the harvested porcine stomach 116 to simulate the human bladder and associated urethra.

As best shown in schematic diagram of the surgical training model 100 in FIG. 2, a harvested porcine ureter is coupled to the harvested porcine stomach 116 to simulate at least one round ligament 140. Another harvested porcine ureter is coupled to the harvested porcine stomach 116 to simulate at least one human ovarian ligament 142 that supports the porcine ovaries 146 that may be stitched or glued to the ovarian ligament. Another harvested porcine ureter is coupled to the harvested porcine stomach 116 to simulate at least one human uterine artery 150, which may have a fluid pump 152 coupled to the simulated uterine artery to pump simulated human blood through the at least one human uterine artery. In this example, the fluid pump 152 may be connected also to a reservoir 154 of simulated human blood, which provides the reservoir of simulated blood that is pumped or pulsed through the simulated uterine artery 150.

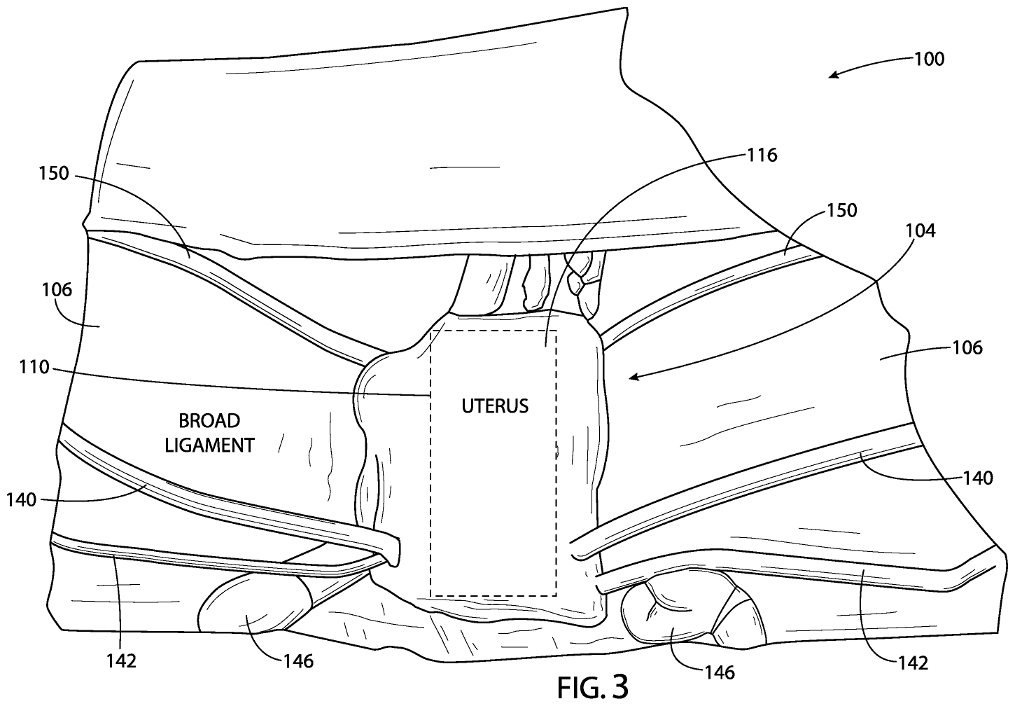

Referring now to FIG. 3, there is shown an image of the harvested porcine leaf fat membrane simulating the broad ligaments 106 and laid flat, and coupled to the harvested porcine stomach 116 that forms an outer portion of the simulated human uterus 104. The leaf fat membrane simulates the human broad ligaments 106, and in this example, the left and right broad ligaments. The harvested porcine stomach 116 is enclosed around the optional spacer 110, which is not shown in detail in FIG. 3, and instead, shown by the dashed lines. The harvested porcine ureters coupled to the harvested porcine stomach 116 that simulate the human ovarian ligaments 142 support the porcine ovaries 146. The harvested porcine ureters that simulate the round ligaments 140 are coupled to the harvested porcine stomach 116, together with the harvested porcine ureters that are coupled to the harvested porcine stomach 116 to simulate the uterine arteries 150. One of the uterine arteries 150 may have the fluid pump 152 coupled thereto.

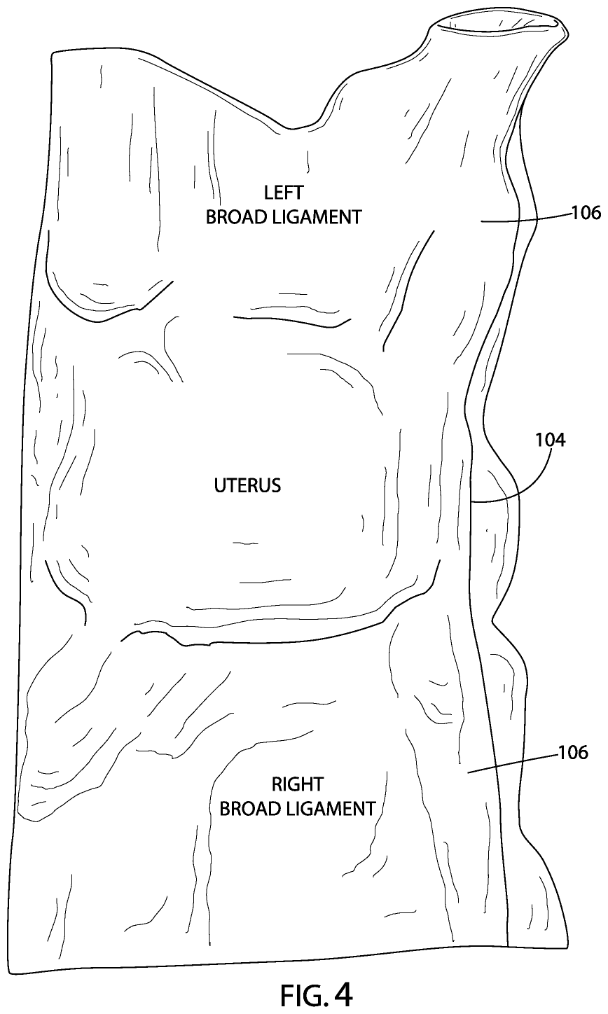

Referring now to FIG. 4, an image of a portion of the surgical training model 100 shows the harvested porcine leaf fat membrane as the broad ligaments 106 folded over to sandwich between the two sections of that leaf fat membrane the simulated human uterus 104 formed from the optional spacer 110 and the harvested porcine stomach 116 around the spacer. The harvested porcine uterus portion 120 is received within the recess 112, but not illustrated in detail.

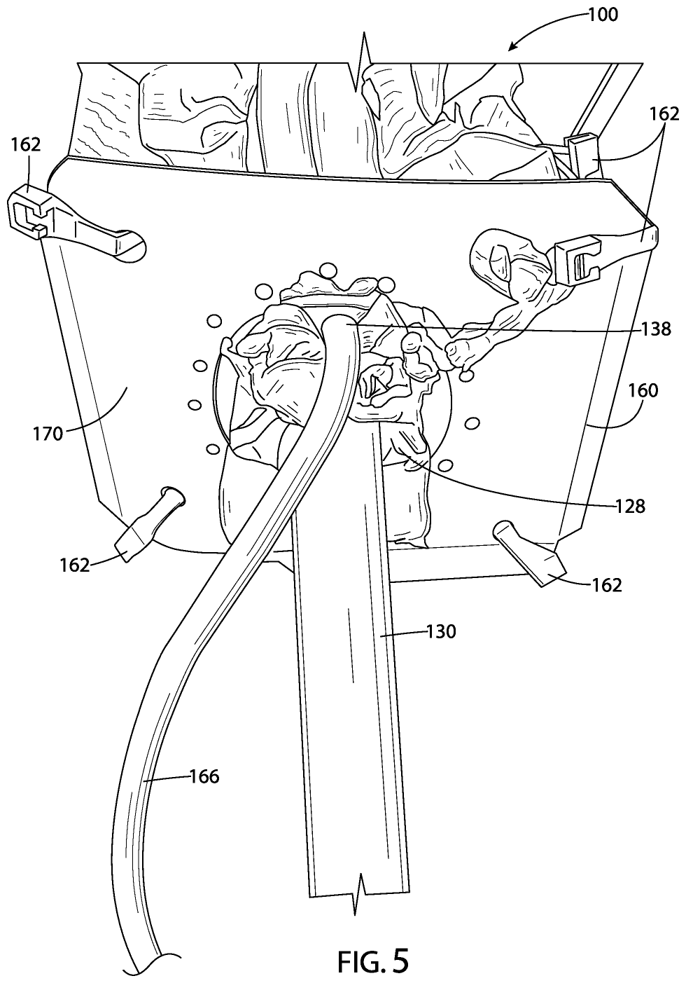

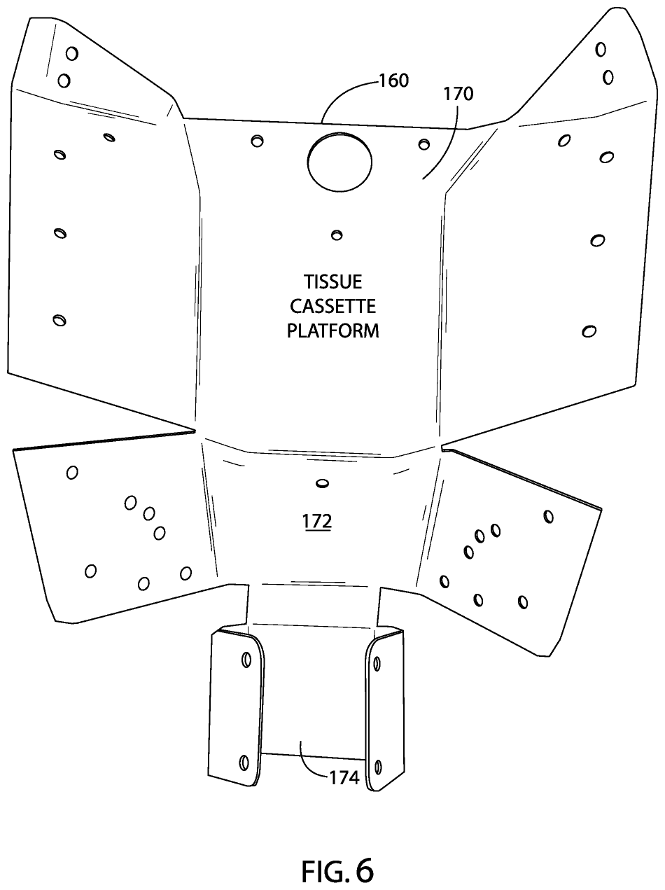

The surgical training model 100 is preferably mounted on a tissue cassette platform 160 as shown in the end view of FIG. 5, which corresponds in this example to the female perineum. The tissue cassette platform 160 may be removably connected to a mannequin (not shown) to facilitate surgical training. The tissue cassette platform 160 supports the surgical training model 100 and may be retained thereon by plastic or other fasteners 162 shown in FIG. 5. The vaginal manipulator 130 and a Foley catheter 166 are illustrated and are inserted into the simulated vagina 128 and urethra 138 respectively. Another example of the tissue cassette platform 160 is shown in the plan view of FIG. 6 and shows an inclined end 170 shown at that end portion also in FIG. 5, and a planar platform 172 on which the surgical training model 100 rests and may be secured. Tubes or other hoses that supply pneumatic or other fluid, such as fake blood for simulated air or blood flow, may pass through the reduced size end 174 opposite the inclined end 170 and connect to any simulated organs at the surgical training model 100, which may receive a pulsating blood flow. Tubes can be retained onto the tissue cassette platform 160 via the tabs at the reduced size end 174.

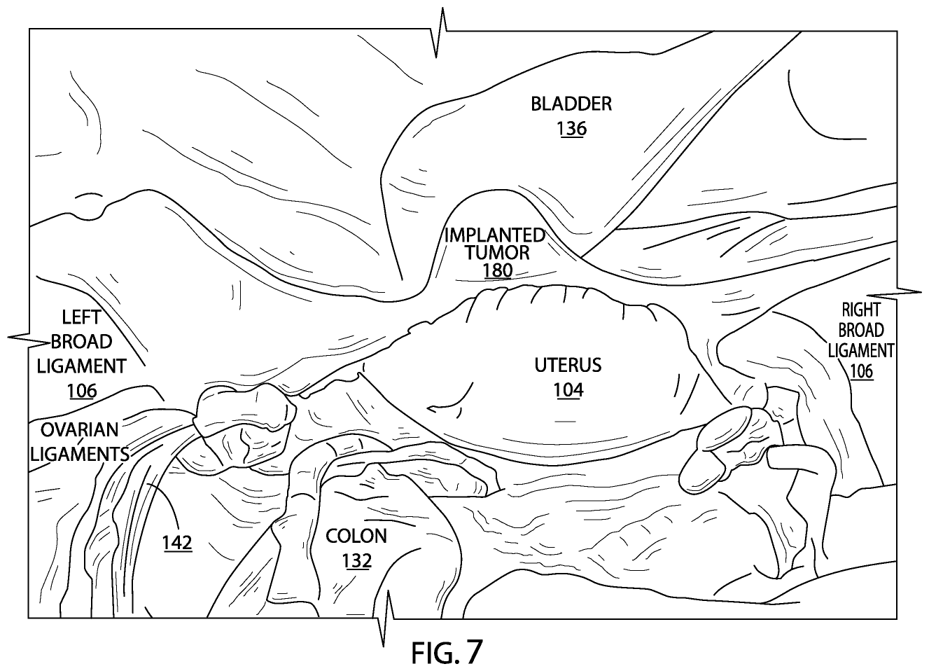

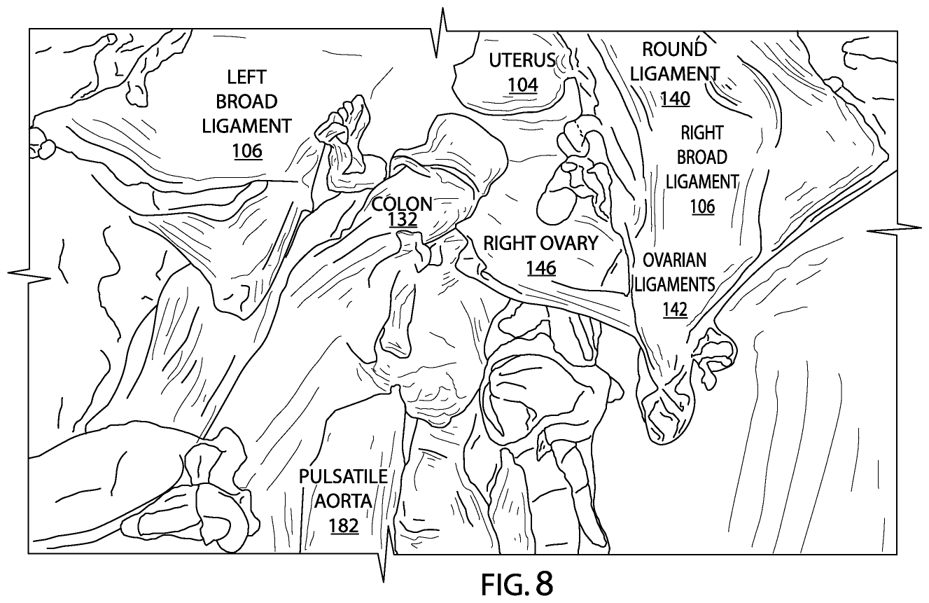

FIG. 7 is a top view image of the surgical training model 100 showing the different simulated organs such as the bladder 136, simulated human uterus 104, the colon 132, the ovarian ligaments 142, and the left and right broad ligaments 106. A simulated tumor 180 is shown within the surgical training model 100 and could be stitched, glued, or pressed within the surgical training model 100 for surgical training and practice in removing tumors in the female pelvic area. Another image similar to FIG. 7, but showing the exposed organs, is illustrated in FIG. 8, also showing the simulated human uterus 104, pulsatile aorta 182, the ovarian ligaments 142, the right ovary 146, the round ligament 140, and left and right broad ligaments 106. As will be explained in detail below, the different simulated organs and tissue may be dyed different colors.

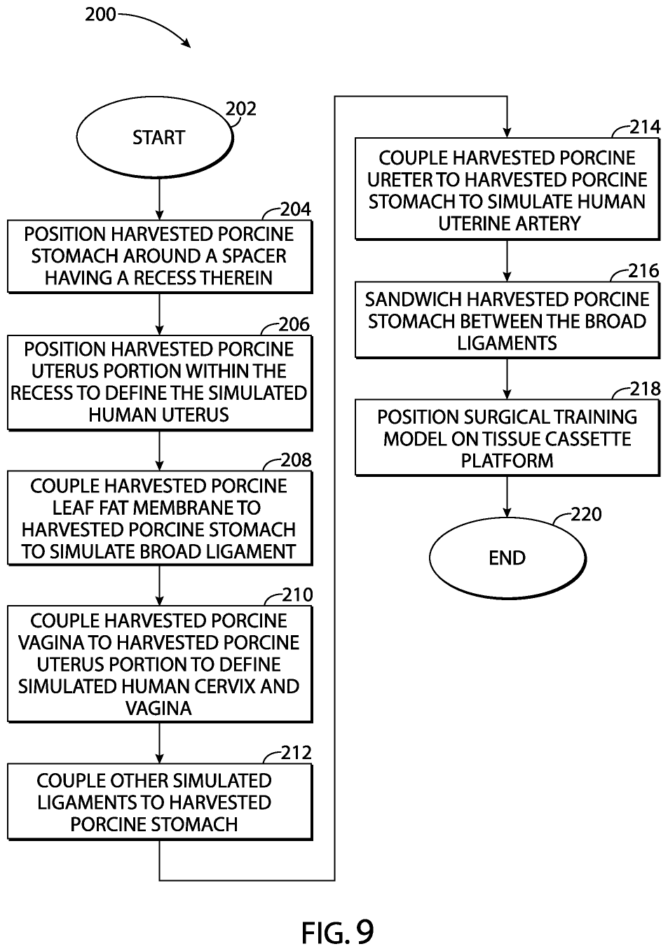

Referring now to FIG. 9, there is illustrated generally at 200 a high-level flowchart showing a method for making the surgical training model 100. The process starts (Block 202) and the harvested porcine stomach 116 is positioned around an optional spacer 110 having a recess 112 therein (Block 204). In some embodiments, the spacer 110 may be omitted. The harvested porcine uterus portion 120 is positioned within the recess 112 to define the simulated human uterus 104 (Block 206). A harvested porcine leaf fat membrane is coupled to the harvested porcine stomach 116 to simulate at least one human broad ligament 106, and in this example, the left and right broad ligaments (Block 208). A harvested porcine vagina 128 is coupled to the harvested porcine 120 uterus portion to define a simulated human cervix 124 and vagina 128 (Block 210). The other simulated ligaments 140, 142, such as formed from the harvested porcine ureter, are coupled to the harvested porcine stomach 116 (Block 212). The harvested porcine ureter is coupled to the harvested porcine stomach to simulate the at least one human uterine artery 150 (Block 214). The surgical training model 100 is completed by sandwiching the harvested porcine stomach 116 that includes the optional spacer 110 between the harvested porcine leaf fat membrane as the broad ligaments 106 (Block 216). The surgical training model 100 is positioned on the tissue cassette platform 160 (Block 218). The process ends (Block 220).

The surgical training model 100 as described operates as a gynecological surgery training simulator and is secured to the tissue cassette platform 160 (FIG. 6), allowing for the practicing of the robotic and other surgical skills required for a variety of gynecological procedures. This surgical training model 100 allows for surgical training on real tissue in a real-time, simulated surgical environment, such as at a university medical school or hospital training facility. The harvested porcine tissue is excess tissue from pigs that had been harvested for food production, in an example. Since the pig (porcine) female anatomy is significantly different from the female human anatomy, the harvested porcine tissue is reconfigured and adapted to closely reflect the human female anatomy.

The surgical training model 100 in an example rests on a formable synthetic platform, such as the tissue cassette platform 160, which may be formed from Kydex, and operable on another general training platform as part of a surgical simulator for manual, laparoscopic, or robotic surgical training and configured to be removably connected to a mannequin.

A real tissue cassette may be top covered with pork belly tissue. The pork belly may be modified over the sacrum into a ligament like structure required for performance of a sacrocolpopexy. A sacral artery and vein may be placed over this ligament. A pulsatile aorto-iliac complex may be added to the pork belly.

Because the pig has a bifid uterus, which is anatomically significantly different from the singular human uterus, the single simulated human uterus 104 has been constructed, in this non-limiting example, using 1.5 inch or 2.0 inch foam pipe insulation as the optional spacer 110, approximately 3.0 inches long, wrapped in duct tape and covered with the harvested porcine stomach 116. The foam forming the spacer 110 may be compressed to a more oval shape and tapered at its inferior end.

The broad ligaments 106 on each side of the simulated human uterus 104 may be constructed by sandwiching the simulated human uterus 104 between two sheets of defatted leaf fat membrane. This sandwiched construction includes the simulated human uterus 104 as its central component. This results in the inclusion of the simulated human ovarian ligaments 142 to suspend the ovaries 146 and fallopian tubes, the simulated human round ligaments 140, and the simulated human uterine arteries 150 on each side. These vessels are sutured to the side wall of the simulated human uterus 104 on each side prior to sandwiching between the simulated human broad ligaments 106 formed from the defatted leaf fat membrane.

A simulated ovarian complex includes the native harvested porcine tissue trimmed from the pig uterine horn. The simulated human round ligaments 140 are a stripped pig ureter. The simulated human uterine arteries 150 are lengths of pig ureter passed though the simulated human uterus 104 to allow for perfusion and pulsation. The standard porcine pelvic block is modified so that the porcine uterus is trimmed and the adnexa are removed.

The simulated human vagina 128 is formed from the natural vaginal section of the harvested porcine tissue and is dilated to allow passage of a three-fourths (¾) inch tube as the vaginal manipulator 130 (FIG. 5). A purse string, such as used for sutures, may be placed around the cervical end of the vagina 128 to stop the tube as the vaginal manipulator 130 at a point that simulates the human cervix 124. This is about 2 centimeters up from the vesicle vaginal fold. The porcine modified pelvic block is placed onto the covered tissue cassette platform 160. The sigmoid colon 132 and its associated mesentery may be glued to the sacrum. Ureters that are native to the porcine pelvic block are placed from the bladder down on the pork belly and positioned to replicate as closely as possible the course in human anatomy.

The broad ligaments 106 may be attached to the modified pelvic block by pulling the excess, but trimmed porcine uterus up through the hole or recess 112 inside the optional spacer 110 and simulated human uterus 104. It is pulled through so that the base of the human simulated uterus 104 is just above the human simulated cervix 124. It is secured in place and the harvested porcine stomach 116 is closed at the top end of the human simulated uterus 104. Each end of the human simulated uterine artery 150 is pulled out through the pork belly laterally and connected to plastic tubing, which circles back underneath the pork belly. The ends are connected together allowing for perfusion of the two “vessels” as a continuous loop with simulated blood via the fluid pump 152.

The suspensory ovarian ligaments 142 of the ovaries and the round ligaments 140 on each side are secured to the lateral wall of the simulated human uterus 104 in an anatomically appropriate position. The lateral edges of the simulated broad ligaments 106 are attached to the lateral wall of the simulated human uterus 104 with either a suture or adhesive. A piece of leaf fat membrane is placed between the vagina 128 and colon 132 and associated rectum to provide the recto-vaginal pouch.

A short vertical wall may be added above the urethra 138, which may be covered with pork belly or a substitute. The bladder 136 is glued to the lower part of the simulated human uterus 104 extending about one-half inch above the cervix 124. A sheet of leaf fat membrane may be placed over the simulated human uterus 104 and undersurface of the bladder 136 and onto a short vertical wall of the uterus, thus suspending the bladder upwards. The ends of the colon 132 with associated rectum, vagina 128, and urethra 138 may be secured to a synthetic plate which is attached to the bottom of the platform 160. Access to the vagina 128 and urethra 138 may be maintained. A plastic tubular device as the vaginal manipulator 130 with an extension may be placed into the vagina 128 up to the cervix 124 with the smaller extension extending up into the simulated human uterus 104. This replicates a uterine manipulator and the vaginal resection line at the simulated human cervix 124. A Foley catheter 166 may be placed into the bladder 136.

Additional modifications may be made. For example, the simulated human uterus 104 may be enlarged by placing one or more masses between the mucosal and serosal wall of the harvested porcine stomach tissue 116 used to make the uterus and beneath the leaf fat membrane sandwiched anterior component. It is possible to glue the ovaries 146, sigmoid colon 132, and/or broad ligaments 106 to replicate adhesions and endometriosis. It is also possible to place tissue that replicates endometriosis on the surfaces of the uterus 104, broad ligaments 106, and/or in a retro-uterine space. It is also possible to place a packet of lymph node tissue derived from the pig to the base of the surgical training 100 model deep to the uterine arteries 150 to allow for lymph node dissection. It is possible to place an optical fiber into the ureter(s) to simulate fluorescence of the ureters for intraoperative identification.

The surgical training model 100 permits different minimally invasive gynecological surgical procedures. These procedures include hysterectomy, unilateral or bilateral oophorectomy, salpingectomy, myomectomy, sacrocolpopexy, retroperitoneal and para-aortic lymph node dissection, resection of endometriosis, and lysis of adhesions.

As noted before, the different organs and tissue shown in the surgical training model 100 may be dyed different colors and retain their color even after freezing and thawing. In a real tissue model, the surgical training model 100 may be formed as a tissue cassette to be placed in a larger mannequin for surgical training. Because the tissue includes real animal tissue, it may be desirable to freeze the tissue for storage. This can extend the usable lifetime of the surgical training model 100. Before use, the surgical training model 100 can be thawed and the cassette placed in an appropriate anatomical fashion within the mannequin.

However, freezing real tissue can affect the color of the tissue, which impacts the training experience. The dye used here can allow a more realistic training experience by enhancing the color of the tissue. Different colors can be applied to different tissue types or parts of the surgical training model 100.

The creation of surgical simulation models includes the described surgical training model 100, uses a wide variety of organs and tissue types harvested from a porcine slaughterhouse. These organs and tissue types are combined in a way so as to closely mirror that anatomy of the human body. Tissues and organs are held together using glue, sutures, and zip-ties. An issue that has been identified is the loss of coloration post-slaughter and model assembly.

It is possible to use tissue coloration and identify appropriate add-on concentrations, colors, and conditions to enhance surgical model coloration. For example, different types of tissue may be colored different colors with different colored dye. The pelvic area may be pink/tan. Fat tissue may be yellow/orange. The pericardium may be red/pink. The venous tissue may be blue.

Dyes may be classified by the type of chemical interaction they have with their substrate. The substrate may be a synthetic material, such as polyester or nylon, or a natural material, such as wool or cotton. Materials such as porcine tissues and organs are considered natural and within natural materials, there are two main types of polymers that can be dyed, and those include proteins and starches. For porcine and similar animal tissues and organs that are used to represent human tissue, a large percentage of the structure is composed of collagen, a naturally occurring protein. Collagen can easily be targeted using acid dyes. Acid dyes target the amino group of the collagen to form a covalent bond with the collagen protein. Dyes may include a combination of acid dyes and direct dyes to provide a solution with more versatility. Each dye may be included within a color databank that includes recommended add-on percentages and dwell times.

Dye application into harvested porcine or other tissue can be done using a dunking method with a specified tissue dwell time. From a production standpoint, soaking tissue blocks prior to model assembly is an efficient dyeing method. It was determined that optimal soaking conditions included a dye bath consisting of a specific dye to water ratio (outlined below), an elevated bath temperature (outlined below), and a dwell time of 30 to 45 seconds. Following the soaking of the tissues in the dyebath, the tissues are thoroughly rinsed in cold running water to remove any excess dye from the tissue surface. In some embodiments, the tissue may be soaked in the dye bath at an elevated temperature relative to room temperature to help the tissue absorb or otherwise take in the dye. The dye bath temperature may be selected such that the tissue absorbs the dye color, but such that the temperature is below a threshold that would affect the performance of the tissue in surgical training. By way of example, in some embodiments, the bath temperature may be selected to be in the range of 30° C. to 100° C., and in some embodiments, the bath temperature may be selected to be around 41.5° C.

For example, the peritoneum may be dyed using 4.0 to 6.0 mL (and in an example 5.07 mL) Scarlet dye; 1.4 to 2.0 mL (and in an example 1.691 mL) Lemon Yellow dye; and 900 to 1,100 mL (and in an example 1,000 mL) Water. Fat tissue may be dyed using 24.0 to 29.0 mL (and in an example 26.498 mL) Golden Yellow dye; and 900 to 1,100 mL (and in an example 1,000 mL) Water. Pelvic tissue may be dyed using 45 to 55 mL (and in an example 50.932 mL) Petal Pink dye; 24.0 to 29.0 mL (and in an example 27.602) Tan Bronce dye; and 900 to 1,100 mL (and in an example 1,000 mL) Water. Venous tissue may be dyed using 2.8 to 3.2 mL (and in an example 3.08 mL) Evening Blue dye; and 900 to 1,100 mL (and in an example 1,000 mL) Water.

In an example, dyed tissues were bagged and frozen to determine if color fading occurred following freeze thaw cycles. The results were compared to tissues that were not dyed and had also undergone and equivalent freeze/thaw cycle. Test results found that tissues maintained their colors if they were dyed, compared to the undyed tissues. Dyed tissues were then assessed for changes in tissue quality by evaluating membrane thickness and handling within a robotic surgery exercise. It was determined that the dyed tissues did not differ in handling or membrane thickness when compared to undyed tissues. Finally, tissues were placed on undyed neutral-colored tissues and bleeding from the dyed tissue was assessed.

It was found that tissues containing a large percentage of proteins had minimal to low dye bleeding while tissues that lacked proteins experienced a higher rate of dye bleeding. Bleeding occurs when the dye leeches from the original dyed surface onto another dyed or undyed surface, thus altering the appearance of surrounding surfaces. This effect was mostly observed in the fat components of leaf fat.

Through a series of dye and tissue tests, it was determined that the use of a dye in specific ratios and under specific conditions yields tissues dyed to resemble more lively, and therefore, more realistic tissues for surgical training. This realism helps to improve the overall appearance of the surgical training models both in and out of robotic exercises, which has led to an improved end-user experience. The ability to improve tissue coloration following multiple freeze/thaw cycles improves the long-term quality of products in storage. Simple solutions were implemented to decrease the chances of bleeding from dyed leaf fat by using plastic wrap to provide a barrier between the leaf fat and the underlying dyed tissues. This plastic wrap has the ability to be removed be training and decreases the rate at which bleeding occurs.

The real-tissue surgical training model 100 may be used, for example, with remotely operated, computer-assisted or teleoperated surgical systems, such as those described in, for example, U.S. Pat. No. 9,358,074 (filed May 31, 2013) to Schena et al., entitled “Multi-Port Surgical Robotic System Architecture,” U.S. Pat. No. 9,295,524 (filed May 31, 2013) to Schena et al., entitled “Redundant Axis and Degree of Freedom for Hardware-Constrained Remote Center Robotic Manipulator,” and U.S. Pat. No. 8,852,208 (filed Aug. 12, 2010) to Gomez et al., entitled “Surgical System Instrument Mounting,” each of which is hereby incorporated by reference in its entirety. Further, the real-tissue surgical training model 100 described herein may be used, for example, with a da Vinci® Surgical System, such as the da Vinci X® Surgical System or the da Vinci Xi® Surgical System, both with or without Single-Site® single orifice surgery technology, all commercialized by Intuitive Surgical, Inc., of Sunnyvale, Calif. Although various embodiments described herein are discussed in connection with a manipulating system of a teleoperated surgical system, the present disclosure is not limited to use with a teleoperated surgical system. Various embodiments described herein can optionally be used in conjunction with hand held instruments, such as laparoscopic tools for real-time surgical training with a harvested porcine tissue cassette.

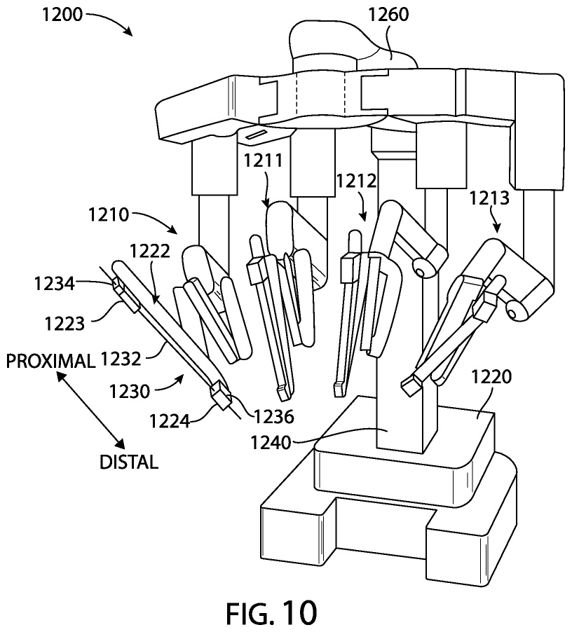

As discussed above, in accordance with various embodiments, surgical tools or instruments of the present disclosure are configured for use in teleoperated, computer-assisted surgical systems employing robotic technology (sometimes referred to as robotic surgical systems). Referring now to FIG. 10, an embodiment of a manipulator system 1200 of a computer-assisted surgical system, to which surgical instruments are configured to be mounted for use, is shown. Such a surgical system may further include a user control system, such as a surgeon console (not shown) for receiving input from a user to control instruments coupled to the manipulator system 1200, as well as an auxiliary system, such as auxiliary systems associated with the DA VINCI X® and DA VINCI XI®, Da Vinci SP.

As shown in the embodiment of FIG. 10, a manipulator system 1200 includes a base 1220, a main column 1240, and a main boom 1260 connected to main column 1240. Manipulator system 1200 also includes a plurality of manipulator arms 1210, 1211, 1212, 1213, which are each connected to main boom 1260. Manipulator arms 1210, 1211, 1212, 1213 each include an instrument mount portion 1222 to which an instrument 1230 may be mounted, which is illustrated as being attached to manipulator arm 1210.

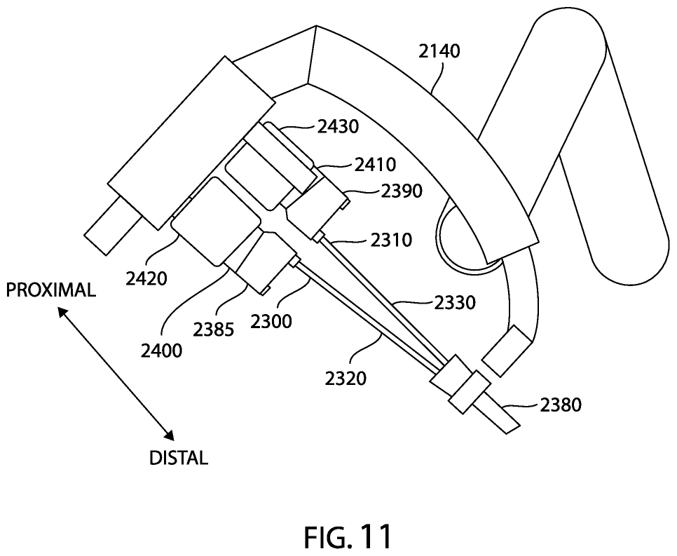

Instrument mount portion 1222 may include a drive assembly 1223 and a cannula mount 1224, with a transmission mechanism 1234 of the instrument 1230 connecting with the drive assembly 1223, according to an embodiment. Cannula mount 1224 is configured to hold a cannula 1236 through which a shaft 1232 of instrument 1230 may extend to a surgery site during a surgical procedure. Drive assembly 1223 contains a variety of drive and other mechanisms that are controlled to respond to input commands at the surgeon console and transmit forces to the transmission mechanism 1234 to actuate the instrument 1230. Although the embodiment of FIG. 11 shows an instrument 1230 attached to only manipulator arm 1210 for ease of viewing, an instrument may be attached to any and each of manipulator arms 1210, 1211, 1212, 1213.

Other configurations of surgical systems, such as surgical systems configured for single-port surgery, are also contemplated. For example, with reference now to FIG. 11, a portion of an embodiment of a manipulator arm 2140 of a manipulator system with two surgical instruments 2300, 2310 in an installed position is shown. The surgical instruments 2300, 2310 can generally correspond to different instruments used for real-time tissue training using the harvested porcine tissue cassette. For example, the embodiments described herein may be used with a DA VINCI SP® Surgical System, commercialized by Intuitive Surgical, Inc. of Sunnyvale, Calif. The schematic illustration of FIG. 11 depicts only two surgical instruments for simplicity, but more than two surgical instruments may be mounted in an installed position at a manipulator system as those having ordinary skill in the art are familiar. Each surgical instrument 2300, 2310 includes a shaft 2320, 2330 having at a distal end a moveable end effector or an endoscope, camera, or other sensing device, and may or may not include a wrist mechanism (not shown) to control the movement of the distal end.

In the embodiment of FIG. 11, the distal end portions of the surgical instruments 2300, 2310 are received through a single port structure 2380 to be introduced into the harvested porcine tissue through the opening of the mouth and associated upper and lower jaws and into communication with the oropharynx region. As shown, the port structure includes a cannula and an instrument entry guide inserted into the cannula. Individual instruments are inserted into the entry guide to reach a surgical site corresponding to the oropharynx region of the porcine tissue that simulates the oropharynx region of the human body.

Other configurations of manipulator systems that can be used in conjunction with the present disclosure can use several individual manipulator arms. In addition, individual manipulator arms may include a single instrument or a plurality of instruments. Further, as discussed above, an instrument may be a surgical instrument with an end effector or may be a camera instrument or other sensing instrument utilized during a surgical procedure to provide information, (e.g., visualization, electrophysiological activity, pressure, fluid flow, and/or other sensed data) of a remote surgical site.

Transmission mechanisms 2385, 2390 are disposed at a proximal end of each shaft 2320, 2330 and connect through a sterile adaptor 2400, 2410 with drive assemblies 2420, 2430, which contain a variety of internal mechanisms (not shown) that are controlled by a controller (e.g., at a control cart of a surgical system) to respond to input commands at a surgeon side console of a surgical system to transmit forces to the force transmission mechanisms 2385, 2390 to actuate surgical instruments 2300, 2310.

The embodiments described herein are not limited to the embodiments of FIGS. 10 and 11, and various other teleoperated, computer-assisted surgical system configurations may be used with the embodiments described herein. The diameter or diameters of an instrument shaft and end effector are generally selected according to the size of the cannula with which the instrument will be used and depending on the surgical procedures being performed.

This description and the accompanying drawings that illustrate various embodiments should not be taken as limiting. Various mechanical, compositional, structural, electrical, and operational changes may be made without departing from the scope of this description and the invention as claimed, including equivalents. In some instances, well-known structures and techniques have not been shown or described in detail so as not to obscure the disclosure. Like numbers in two or more figures represent the same or similar elements. Furthermore, elements and their associated features that are described in detail with reference to one embodiment may, whenever practical, be included in other embodiments in which they are not specifically shown or described. For example, if an element is described in detail with reference to one embodiment and is not described with reference to another embodiment, the element may nevertheless be claimed as included in the other embodiment.

For the purposes of this specification and appended claims, unless otherwise indicated, all numbers expressing quantities, percentages, or proportions, and other numerical values used in the specification and claims, are to be understood as being modified in all instances by the term “about,” to the extent they are not already so modified. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Further, this description's terminology is not intended to limit the invention. For example, spatially relative terms—such as “beneath”, “below”, “lower”, “above”, “upper”, “proximal”, “distal”, and the like—may be used to describe one element's or feature's relationship to another element or feature as illustrated in the figures. These spatially relative terms are intended to encompass different positions (i.e., locations) and orientations (i.e., rotational placements) of a device in use or operation in addition to the position and orientation shown in the figures. For example, if a device in the figures is turned over, elements described as “below” or “beneath” other elements or features would then be “above” or “over” the other elements or features. Thus, the example term “below” can encompass both positions and orientations of above and below. A device may be otherwise oriented (rotated 90 degrees or at other orientations) and the spatially relative descriptors used herein interpreted accordingly.

Further modifications and alternative embodiments will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various embodiments shown and described herein are to be taken as examples. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the spirit and scope of the present teachings and following claims.

It is to be understood that the particular examples and embodiments set forth herein are non-limiting, and modifications to structure, dimensions, materials, and methodologies may be made without departing from the scope of the present teachings.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A surgical training model for simulating gynecological surgery comprising:
a simulated human uterus comprising:
a first inner portion comprising a harvested porcine uterus, and
a second outer portion comprising harvested porcine tissue,
wherein the second outer portion surrounds the first inner portion, and wherein the simulated human uterus is sized and shaped to replicate a human uterus; and
a simulated human broad ligament comprising porcine tissue.

2. The surgical training model of claim 1 wherein the second outer portion of the simulated human uterus comprises harvested porcine tissue other than a porcine uterus.

3. The surgical training model of claim 2 wherein the second outer portion comprises harvested porcine stomach.

4. The surgical training model of claim 1 wherein the simulated human uterus comprises a third intermediate portion comprising a spacer comprising synthetic material, the spacer being positioned between the first inner portion and the second outer portion.

5. The surgical training model of claim 1 comprising a harvested porcine vagina coupled to the harvested porcine uterus to define a simulated human vagina.

6. The surgical training model of claim 1 wherein said simulated human broad ligament comprises harvested porcine leaf fat membrane.

7. The surgical training model of claim 1 comprising a harvested porcine ureter coupled to the second outer portion to define a simulated round ligament.

8. The surgical training model of claim 1 comprising a harvested porcine ureter coupled to the second outer portion to define a simulated human ovarian ligament.

9. The surgical training model of claim 1 comprising a harvested porcine ureter coupled to the second outer portion to define a simulated human uterine artery.

10. The surgical training model of claim 9 comprising a pump coupled to the harvested porcine ureter to simulate human blood flow through the simulated human uterine artery.

11. The surgical training model of claim 1 comprising a harvested porcine bladder and associated urethra adjacent the second outer portion to define a simulated human bladder and associated urethra.

12. The surgical training model of claim 1 comprising a harvested porcine colon adjacent the second outer portion to define a simulated human colon.

13. The surgical training model of claim 1 comprising a tissue cassette on which the simulated human uterus and human broad ligament are received, wherein the tissue cassette is configured to be removably coupled to a mannequin.

14. The surgical training model of claim 1 wherein the simulated human uterus and broad ligament include at least one colored dye to impart a dyed color to the simulated human uterus and broad ligament, wherein the simulated human uterus and broad ligament maintain their dyed color after freezing and thawing.

15. A surgical training model comprising:
a compressible spacer having a recess therein;
a harvested porcine stomach around the spacer;
a harvested porcine uterus portion within the recess to define a simulated human uterus; and
harvested porcine ligament-simulating tissue coupled to the harvested porcine stomach to define a simulated at least one human ligament.

16. The surgical training model of claim 15 comprising a harvested porcine vagina coupled to the harvested porcine uterus portion to define a simulated human cervix and vagina.

17. The surgical training model of claim 15 wherein the compressible spacer comprises a compressible tubular body.

18. The surgical training model of claim 15 wherein the harvested porcine ligament-simulating tissue comprises harvested porcine leaf fat membrane to define a simulated at least one human broad ligament.

19. The surgical training model of claim 15 wherein the harvested porcine ligament-simulating tissue comprises a harvested porcine ureter to define a simulated at least one round ligament.

20. The surgical training model of claim 15 wherein the harvested porcine ligament-simulating tissue comprises a harvested porcine ureter to define a simulated at least one human ovarian ligament.

21. A method for making a surgical training model comprising:
positioning a harvested porcine stomach around a spacer having a recess therein; and
positioning a harvested porcine uterus portion within the recess to define a simulated human uterus.

22. The method of claim 21 comprising coupling a harvested porcine vagina to the harvested porcine uterus portion to define a simulated human cervix and vagina.

23. The method of claim 21 wherein the spacer comprises a compressible tubular body.

24. The method of claim 21 comprising coupling harvested porcine leaf fat membrane to the harvested porcine stomach to define a simulated human broad ligament.

25. The method of claim 21 comprising coupling a harvested porcine ureter to the harvested porcine stomach to define a simulated round ligament.

26. The method of claim 21 comprising coupling a harvested porcine ureter to the harvested porcine stomach to define a simulated human ovarian ligament.
